(19) United States
(12) Patent Application Publication
(10) Pub. No.: US 2022/0188724 A1
(43) Pub. Date: Jun. 16, 2022

(54) MAINTENANCE MANAGEMENT SYSTEM FOR SERVICE PROVIDING APPLICATION, MAINTENANCE MANAGEMENT DEVICE, MAINTENANCE MANAGEMENT METHOD, AND MAINTENANCE MANAGEMENT PROGRAM

(71) Applicant: Nippon Telegraph and Telephone Corporation, Tokyo (JP)

(72) Inventors: Tomoki IKEGAYA, Musashino-shi, Tokyo (JP); Kensuke TAKAHASHI, Musashino-shi, Tokyo (JP); Satoshi KONDO, Musashino-shi, Tokyo (JP)

(21) Appl. No.: 17/432,164

(22) PCT Filed: Feb. 7, 2020
(86) PCT No.: PCT/JP2020/004735

§ 371 Date: Aug. 19, 2021

(30) Foreign Application Priority Data
Feb. 21, 2019 (JP) 2019-029158

(51) Int. Cl. G06Q 10/06; G06Q 50/10

(52) U.S. Cl. CPC G06Q 10/06311; G06Q 50/10

(57) ABSTRACT

There is provided a maintenance management system for an application for providing a service that can easily perform maintenance management processing for the application. A maintenance management system for executing maintenance processing relating to an application for providing a service including a plurality of partial services includes a plurality of operational component functional units, which are provided for the respective partial services and for respective maintenance management functions. Each of the plurality of operational component functional units includes an execution unit that starts an action of a corresponding function upon acquiring a determination result that an action corresponding to another preset maintenance management function has ended in all the partial services and an action notification unit that issues a start message when the action starts and issues an end message when the action ends. The maintenance management system also includes an action merging determination unit that determines, for each maintenance management function, whether the corresponding action has ended in all the partial services based on the issued start and end messages.

### TECHNICAL FIELD

The present invention relates to a maintenance management system, a maintenance management device, a maintenance management method, and a maintenance management program for an application for providing a service.

### BACKGROUND ART

Applications for providing services via networks have become widespread in the related art. With the spread of such applications, service maintenance work has been carried out to monitor the quality of services being provided and the presence or absence of application abnormalities due to the influence of device failures and to perform analysis and recovery as necessary. This service maintenance work is achieved mainly by a maintenance person's judgement based on his or her knowledge and know-how and thus takes time and effort. In particular, efforts have been underway in recent years to automate and alleviate the service maintenance work because maintenance management targets have become complicated due to the spread of services in which a plurality of network functions are combined and BtoBtoX wholesale business models.

### CITATION LIST

### Non Patent Literature

Non Patent Literature 1: Tanji et al (NTT), “Autonomous Management Loop by Componentization and Autonomization of Operation Function,” Jul. 5, 2018, Technical Committee on Information and Communication Management

### SUMMARY OF THE INVENTION

### Technical Problem

When the service maintenance work is automated as described above, processing and determination functions are componentized, and workflows are defined using the connection relationship between the components to achieve the automation.

However, there is a problem that dealing with addition of new functions or changes of functions is troublesome because the connection relationship between the components is also complicated due to the diversification of services.

The present invention has been made in view of the above circumstances and it is an object of the present invention to provide a maintenance management system, a maintenance management device, a maintenance management method, and a maintenance management program for an application for providing a service which can easily perform maintenance management processing for the application.

### Means for Solving the Problem

To solve the above problem, a maintenance management system for an application for providing a service of the present invention is a maintenance management system for executing, as maintenance processing relating to an application for providing a service including a plurality of partial services, a plurality of types of preset maintenance management functions for each of the plurality of partial services, the maintenance management system including a plurality of operational component functional units provided for the respective partial services and for the respective maintenance management functions, each of the plurality of operational component functional units including an execution unit configured to start an action of a corresponding function upon detecting information on a result of determination that an action corresponding to another maintenance management function preset as a preceding stage of the action of the corresponding function has ended in all the partial services, and an action notification unit configured to issue a start message when the action of the corresponding function starts and issue an end message when the action of the corresponding function ends, and an action merging determination unit connected to the plurality of operational component functional units via a message bus and configured to determine, for each of the maintenance management functions, whether the corresponding action has ended in all the partial services based on the start message and the end message issued from the action notification unit of each of the operational component functional units, and transmit, upon determining that the corresponding action has ended in all the partial services, corresponding result information to the plurality of operational component functional units.

A maintenance management device of the present invention is a maintenance management device installed in a maintenance management system for performing maintenance processing relating to an application for providing a service including a plurality of partial services, the maintenance management device being configured to execute a predetermined maintenance management function for a predetermined partial service, the maintenance management device being connected to an action merging determination unit via a message bus, the action merging determination unit being configured to determine, for each maintenance management function, whether a corresponding action has ended in all the partial services, the maintenance management device including an execution unit configured to start an action of a corresponding function when the action merging determination unit has determined that an action corresponding to another maintenance management function preset as a preceding stage of the action of the corresponding function has ended in all the partial services, and an action notification unit configured to issue a start message when the action of the corresponding function starts and issue an end message when the action of the corresponding function ends to allow the action merging determination unit to execute processing of determining whether the corresponding action has ended in all the partial services.

A maintenance management method of the present invention is a maintenance management method for a maintenance management device installed in a maintenance management system for performing maintenance processing relating to an application for providing a service including a plurality of partial services, the maintenance management device being configured to execute a predetermined maintenance management function for a predetermined partial service, the maintenance management device being connected to an action merging determination unit via a message bus, the action merging determination unit being configured to determine, for each maintenance management function, whether a corresponding action has ended in all the partial services, the maintenance management method including by the maintenance management device, starting an action of a corresponding function when the action merging determination unit has determined that an action corresponding to another maintenance management function preset as a preceding stage of the action of the corresponding function has ended in all the partial services, and by the maintenance management device, issuing a start message when the action of the corresponding function starts and issuing an end message when the action of the corresponding function ends to allow the action merging determination unit to execute processing of determining whether the corresponding action has ended in all the partial services.

A maintenance management program of the present invention is a maintenance management program for a maintenance management device installed in a maintenance management system for performing maintenance processing relating to an application for providing a service including a plurality of partial services, the maintenance management device being configured to execute a predetermined maintenance management function for a predetermined partial service, the maintenance management device being connected to an action merging determination unit via a message bus, the action merging determination unit being configured to determine, for each maintenance management function, whether a corresponding action has ended in all the partial services, the maintenance management program causing the maintenance management device to execute starting an action of a corresponding function when the action merging determination unit has determined that an action corresponding to another maintenance management function preset as a preceding stage of the action of the corresponding function has ended in all the partial services, and issuing a start message when the action of the corresponding function starts and issuing an end message when the action of the corresponding function ends to allow the action merging determination unit to execute processing of determining whether the corresponding action has ended in all the partial services.

### Effects of the Invention

According to the maintenance management system, the maintenance management device, the maintenance management method, and the maintenance management program for the application for providing the service according to the present invention, it is possible to easily perform maintenance management processing for the application for providing the service.

### BRIEF DESCRIPTION OF DRAWINGS

FIG. 1 is an overall configuration diagram illustrating a configuration of a maintenance management system according to an embodiment of the present invention.

FIG. 2 is a block diagram illustrating a configuration of the maintenance management system system according to the embodiment of the present invention.

FIG. 3 is a sequence diagram illustrating a synchronization process for operation transition between a plurality of operational component functional units which is performed in the maintenance management system according to the embodiment of the present invention.

FIG. 4 is a flowchart illustrating a process for avoiding overlapping execution of operations which is performed in the maintenance management system according to the embodiment of the present invention.

FIG. 5(a) illustrates an example of common information in a start message and an end message issued in the maintenance management system according to the embodiment of the present invention and FIG. 5(b) illustrates an example of a start message that uses the common information illustrated in FIG. 5(a).

### DESCRIPTION OF EMBODIMENTS

Hereinafter, a maintenance management system according to an embodiment of the present invention will be described in which maintenance operations relating to an application for providing a service X including a plurality of partial services (partial services A, B, and C) are componentized into a plurality of types of operational component functional units, and the operational component functional units are automated to perform processing in cooperation.

Function types that constitute the maintenance management functions of the present embodiment include information collection, information processing, information analysis, test, configuration change, and a maintenance worker UI. The operational component functional unit is constructed for each partial service and for each function type and mounted in the maintenance management system. The outline of each function type is described below.

[Information Collection] A function of executing information collection from the service environment using SNMP, REST-API, or the like. This also includes executing reversible information processing such as adding a time stamp and calculating a difference value.

[Information Processing] A function of executing irreversible time series/character string processing such as noise removal, correlation calculation, feature/keyword extraction, and statistical processing and executing visualization.
[Information Analysis] A function of generating new information using existing information such as abnormality determination, classification for clustering, prediction, or state estimation.
[Test] A function of generating and sending test traffic using functions such as ping, curl and 1call.
[Configuration Change] A function of executing specific change operations for services such as change of user accommodation, addition/regeneration of virtual resources, and device restart.

Configuration of Maintenance Management System According to Embodiment

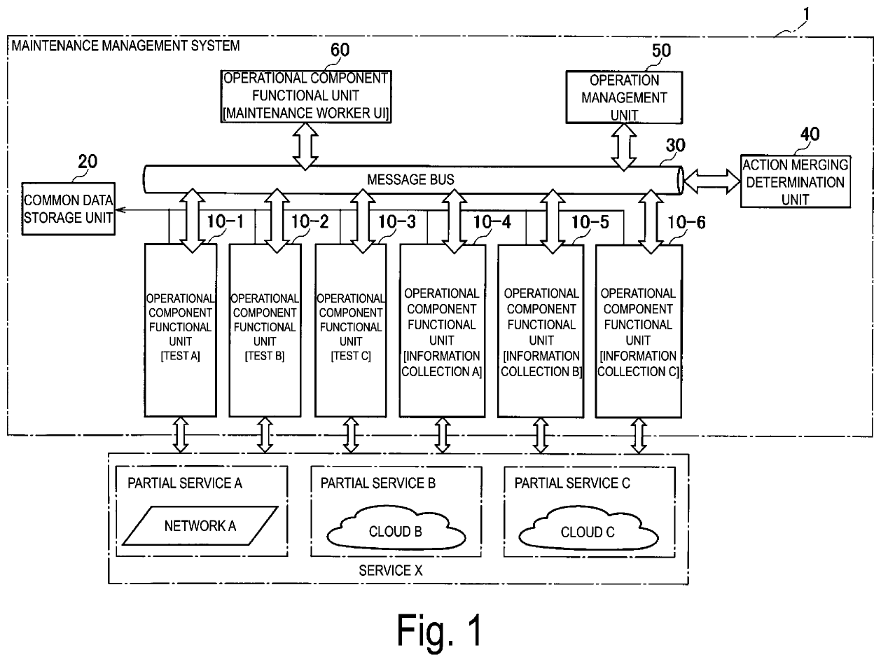

A configuration of a maintenance management system for an application for providing a service according to an embodiment of the present invention will be described with reference to FIG. 1. The maintenance management system 1 according to the present embodiment is a system that performs maintenance management of an application for providing a service X formed by combining a partial service A using a network A, a partial service B using a cloud B, and a partial service C using a cloud C.

The maintenance management system 1 includes operational component functional units 10-1 to 10-6, and a common data storage unit 20, an action merging determination unit 40, an operation management unit 50, and an operational component functional unit 60 which are connected to the operational component functional units 10-1 to 10-6. The operational component functional units 10-1 to 10-6 are a plurality of maintenance management devices. One maintenance management device is set for each of the partial services A, B, and C of the service X and for each of a plurality of function types used for maintenance processing. The action merging determination unit 40 is connected to the operational component functional units 10-1 to 10-6 via a message bus 30. The operational component functional unit 60 is connected to a maintenance terminal (not illustrated) operated by a maintenance worker and functions as a maintenance worker user interface (UI).

The operational component functional units 10-1 to 10-6 are illustrated in FIG. 1 as an operational component functional unit 10-1, an operational component functional unit 10-2, an operational component functional unit 10-3, an operational component functional unit 10-4, an operational component functional unit 10-5, and an operational component functional unit 10-6. The operational component functional unit 10-1 executes a test function of the partial service A. The operational component functional unit 10-2 executes a test function of the partial service B. The operational component functional unit 10-3 executes a test function of the partial service C. The operational component functional unit 10-4 executes an information collection function of the partial service A. The operational component functional unit 10-5 executes an information collection function of the partial service B. The operational component functional unit 10-6 executes an information collection function of the partial service C.

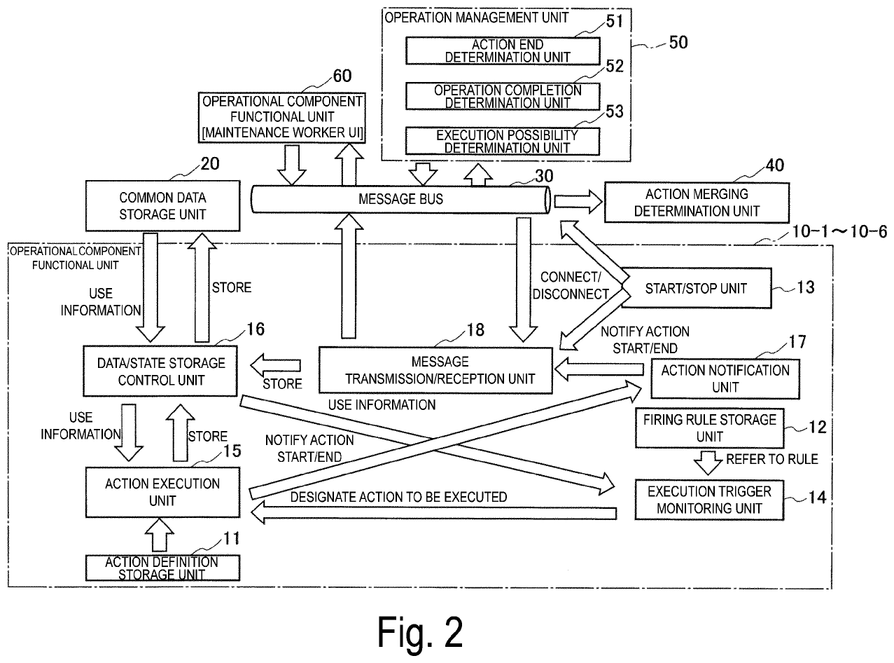

The configuration of each of the operational component functional units 10-1 to 10-6 will be described with reference to FIG. 2. The operational component functional units 10-1 to 10-6 are configured as independent processes in the maintenance management system 1 and each includes an action definition storage unit 11, a firing rule storage unit 12, a start/stop unit 13, an execution trigger monitoring unit 14, an action execution unit 15, a data/state storage control unit 16, an action notification unit 17, and a message transmission/reception unit 18.

The action definition storage unit 11 stores information that defines an action to be executed for each function type as follows. Information (such as a URI or a DB column name) for identifying information will be referred to as key information.

[Information Collection] An action for collecting information of devices using IP addresses of the devices and metrics to be collected as arguments, and storing the collected information in the common data storage 20 unit is defined as an individual collection action for each protocol such as SNMP and Syslog.

[Information Processing] A visualization action for generating a graph for a maintenance worker and a URL for accessing the graph using key information of time series data as an argument is defined.
[Information Analysis] An abnormality detection action for outputting time information of outliers using key information of time series data as an argument is defined. A test result determination action for outputting a determination on a test result using key information of the test result as an argument is also defined.
[Test] An action for executing a test using the source and destination of a test packet as arguments and storing the result in the common data storage unit 20 is defined as an individual test action for each test method.

[Configuration Change] A change action for executing scaling-up/down of virtual resources using the key information and changed state of target resources as arguments is defined.

The firing rule storage unit 12 stores information that defines an execution trigger of an action for each function type as a firing rule as follows.

[Information Collection] A collection action is executed with a lapse of a certain period of time as a trigger. A collection action is also executed with a notification of a result of abnormality detection as a trigger.
[Information Processing] A visualization action is executed with a notification of collection of new information as a trigger.
[Information Analysis] An abnormality detection action is executed with a notification of collection of new information as a trigger. A test result determination action is executed with a notification of execution of a test as a trigger. An information analysis action is executed with a notification of collection of new information and a notification of a result of a test which are caused by an action executed due to detection of an abnormality as a trigger.
[Test] A test action is selected and a message asking whether or not the test is capable of being executed is sent with a notification of a result of abnormality detection as a trigger. The selected test action is executed with a notification of permission to execute the test as a trigger.
[Configuration Change] A restart action and a change action are selected and a message asking whether or not the actions is capable of being executed is sent with a result of the test as a trigger. Corresponding actions are executed with a reply to the message asking whether or not the actions are capable of being executed as a trigger.

When each of the operational component functional units 10-1 to 10-6 is mounted and starts on the maintenance management system 1, the start/stop unit 13 in the operational component functional unit connects the operational component functional unit to the message bus 30 and sets a message-waiting state of the message transmission/reception unit 18 to an on state. When the operational component functional unit has stopped, the start/stop unit 13 disconnects the operational component functional unit from the message bus 30 and sets the message-waiting state of the message transmission/reception unit 18 to an off state.

The execution trigger monitoring unit 14 monitors execution triggers of actions based on the firing rules stored in the firing rule storage unit 12. Upon recognizing an action to be executed, the execution trigger monitoring unit 14 designates execution of the action to the action execution unit 15.

The action execution unit 15 executes the action designated by the execution trigger monitoring unit 14 based on the action definition information stored in the action definition storage unit 11.

The data/state storage control unit 16 causes the common data storage unit 20 to store necessary data among result information of actions executed by the action execution unit 15. The data/state storage control unit 16 also acquires, from the common data storage unit 20, data that the action execution unit 15 is to use when executing an action and transmits the acquired data to the action execution unit 15. The data/state storage control unit 16 also causes the common data storage unit 20 to store data of messages that have been received from other operational component functional units via the message transmission/reception unit 18.

The action notification unit 17 issues a start message when an action of a corresponding function starts and issues an end message when the action of the function ends.

The message transmission/reception unit 18 sends or receives messages to or from other operational component functional units, the action merging determination unit 40, and the operation management unit 50.

The common data storage unit 20 stores data commonly used by the operational component functional units 10-1 to 10-6 such as account information, collected performance information, and configuration information of the devices.

The action merging determination unit 40 is connected to the operational component functional units 10-1 to 10-6 via the message bus 30 and determines, for each maintenance management function, whether or not a corresponding action has ended in all the partial services based on start and end messages issued from the action notification units 17 of the operational component functional units. Then, upon determining that the corresponding action has ended in all the partial services, the action merging determination unit 40 transmits corresponding result information to the operational component functional units 10-1 to 10-6.

The operation management unit 50 holds a message table for managing messages issued in the maintenance management system 1 and includes an action end determination unit 51, an operation completion determination unit 52, and an execution possibility determination unit 53 which use the message table to perform processing.

The action end determination unit 51 determines whether or not an action in a specific operational component functional unit has ended based on information in the message table.

The operation completion determination unit 52 determines, for each partial service and for each maintenance operation, whether or not all actions associated with a series of maintenance operations that are executed in cooperation among the plurality of operational component functional units in the maintenance management system 1 have been completed.

Upon acquiring a message instructing execution of an action relating to a function type of any of the partial services from the operational component functional unit 60 (a maintenance worker UI), the execution possibility determination unit 53 determines whether or not there is a maintenance operation being executed in the partial service based on a determination result of the operation completion determination unit 52. Then, if there is a corresponding maintenance operation being executed, the execution possibility determination unit 53 determines that the instructed function is incapable of being executed.

Operation of Maintenance Management System According to Embodiment

Next, an operation of the maintenance management system 1 according to the present embodiment will be described. In the present embodiment, when each of the operational component functional units (processes) 10-1 to 10-6 is mounted and starts on the maintenance management system 1, the start/stop unit 13 in the operational component functional unit connects the operational component functional unit to the message bus 30 and sets a message-waiting state of the message transmission/reception unit 18 to an on state. Then, the execution trigger monitoring unit 14 in each of the operational component functional units 10-1 to 10-6 monitors execution triggers of actions based on the firing rules stored in the firing rule storage unit 12. Upon recognizing an action to be executed, the execution trigger monitoring unit 14 designates execution of the action to the action execution unit 15. The action execution unit 15 executes the designated action based on the action definition information stored in the action definition storage unit 11. The action execution unit 15 executes an action to be executed, which has been recognized by the execution trigger monitoring unit 14, in the above manner, so that each of the operational component functional units 10-1 to 10-6 autonomously operates for the maintenance management processing.

A description will be given of (1) a synchronization process for operation transition between a plurality of operational component functional units and (2) a process of avoiding overlapping execution of operations. Both processes are performed in the maintenance management system 1 when each of the operational component functional units 10-1 to 10-6, which monitors execution triggers of actions, executes an action recognized to be executed as described above.

(1) Synchronization Process for Operation Transition Between Plurality of Operational Component Functional Units

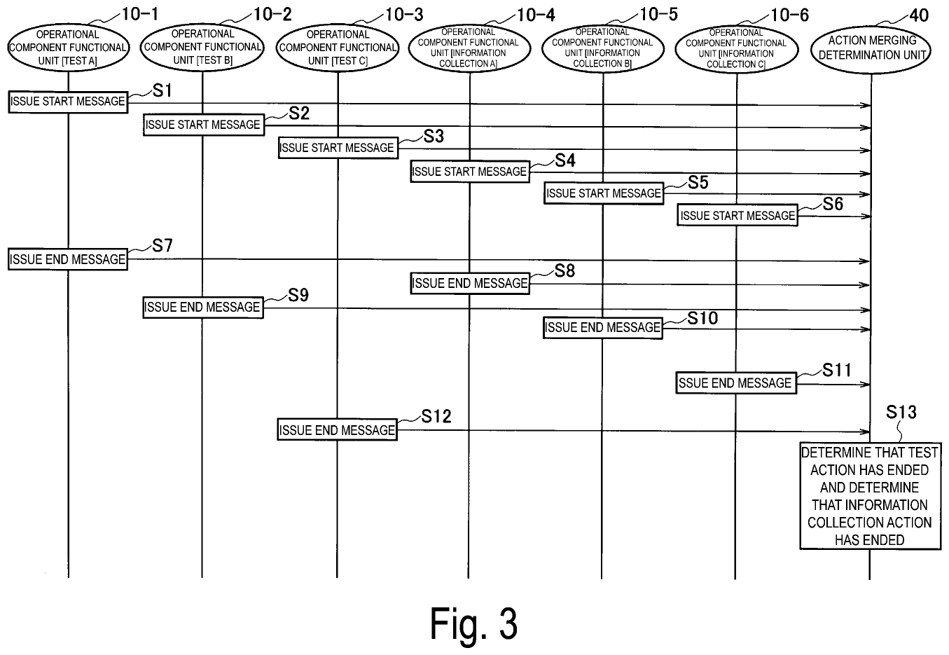

An synchronization process for operation transition between a plurality of operational component functional units will be described with reference to a sequence diagram of FIG. 3.

When an abnormality has been detected in the maintenance management system 1, test and information collection actions are executed for all the partial services A, B, and C in the management target service X based on the firing rules stored in the firing rule storage unit 12. With these test and information collection actions as preceding stages, a transition is made to an information analysis action as a subsequent step, and the information analysis action is executed. When the transition to the information analysis action is made, synchronization needs to be achieved by waiting for the end of actions in all operational component functional units relating to the test and information collection actions which are active at the time of transition, regardless of the number of operational component functional units running in the system 1.

To deal with the above need, a synchronization process for operation transition performed when an abnormality has been detected in the maintenance management system 1, which is performed in the present embodiment, will be described in detail.

When an abnormality has been detected in the system 1, the execution trigger monitoring unit 14 in each of the operational component functional units 10-1 to 10-3 having a test function designates execution of a test action based on the firing rules stored in the firing rule storage unit 12. When execution of the test action has been designated, the action execution unit 15 starts the test action based on the action definition information stored in the action definition storage unit 11.

In each of the operational component functional units 10-1 to 10-3, when the action execution unit 15 has started the test action, the action notification unit 17 issues a test action start message, and the message transmission/reception unit 18 sends the test action start message to the action merging determination unit 40 via the message bus 30 (S1 to S3).

When an abnormality has been detected in the system 1, the execution trigger monitoring unit 14 in each of the operational component functional units 10-4 to 10-6 having an information collection function also designates execution of an information collection action based on the firing rules stored in the firing rule storage unit 12, in parallel with the test action. When execution of the information collection action has been designated, the action execution unit 15 starts the information collection action based on the action definition information stored in the action definition storage unit 11.

In each of the operational component functional units 10-4 to 10-6, when the action execution unit 15 has started the information collection action, the action notification unit 17 issues an information collection action start message, and the message transmission/reception unit 18 sends the information collection action start message to the action merging determination unit 40 via the message bus 30 (S4 to S6). The action merging determination unit 40 recognizes that each of the operational component functional units 10-1 to 10-6 has started the corresponding action.

Thereafter, when each of the operational component functional units 10-1 to 10-6 has ended the action being executed, the action notification unit 17 in each of the operational component functional units 10-1 to 10-6 issues an end message of the corresponding action, and the message transmission/reception unit 18 sends the end message to the action merging determination unit 40 via the message bus 30 (S7 to S11). Each time an end message is received, the action merging determination unit 40 recognizes that a corresponding operational component functional unit has ended an action.

For example, it is assumed that the operational component functional units 10-1 to 10-6 have started the actions at the same time, that the processing time of the test action of the operational component functional unit 10-1 is 5 seconds, that the processing time of the test action of the operational component functional unit 10-2 is 15 seconds, that the processing time of the test action of the operational component functional unit 10-3 is 60 seconds, that the processing time of the information collection action of the operational component functional unit 10-4 is 10 seconds, that the processing time of the information collection action of the operational component functional unit 10-5 is 20 seconds, and that the processing time of the information collection action of the operational component functional unit 10-6 is 40 seconds.

The action merging determination unit 40 updates and recognizes, for each function, the number of actions being executed and the number of actions that have ended each time an end message is received from any of the operational component functional units. For example, at the time of receiving an end message from the operational component functional unit 10-2, the action merging determination unit 40 recognizes that the number of operational component functional units corresponding to the test action is three, that the number of operational component functional units which are executing the action is one, and that the number of operational component functional units which have ended the action is two. The action merging determination unit 40 also recognizes that the number of operational component functional units corresponding to the information collection action is three, that the number of operational component functional units which are executing the action is two, and that the number of operational component functional units which have ended the action is one.

Then, the action merging determination unit 40 determines that all the test actions have ended upon receiving the end messages from the operational component functional units 10-1 to 10-3 and determines that all the information collection actions have ended upon receiving the end messages from the operational component functional units 10-4 to 10-6 (S13).

This determination result is broadcast to each operational component functional unit in the maintenance management system 1 and recognized by an operational component functional unit (not illustrated) relating to information analysis of each service. Then, an information analysis action starts. By performing the processing in this way, the information analysis action starts after all the test and information collection actions end, and the operation transition is made in synchronization among the plurality of operational component functional units.

(2) Process of Avoiding Overlapping Execution of Operations

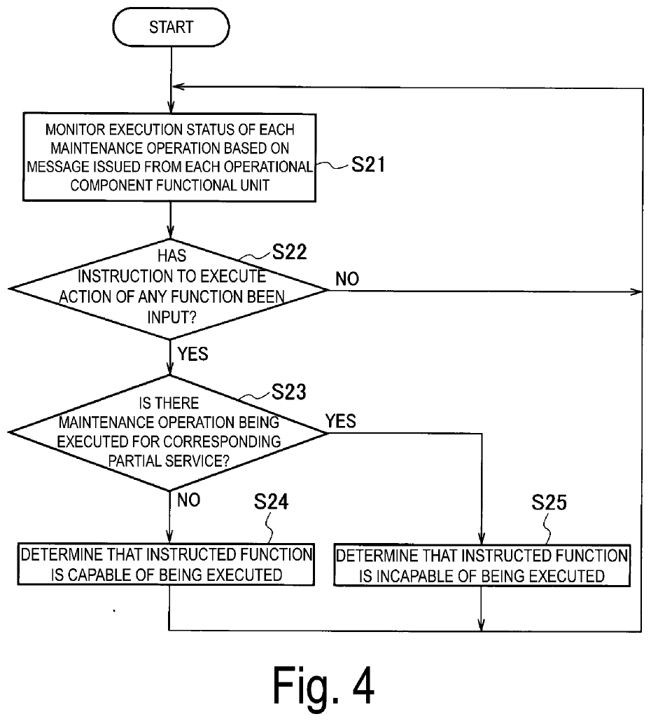

A process of avoiding overlapping execution of operations will be described with reference to FIG. 4.

The operational component functional units 10-1 to 10-6 in the maintenance management system 1 each operate autonomously as described above. At this time, a problem arises if an action involving the restart of an application of a partial service (partial service A, B, or C) or the like is executed in an overlapping manner during execution of another action relating to the same partial service.

To solve this problem, a process of avoiding overlapping execution of maintenance operations in the maintenance management system 1, which is performed in the present embodiment, will be described.

While the maintenance management system 1 is in operation, the operation management unit 50 monitors the execution status of each maintenance operation using a message table based on messages issued from the operational component functional units 10-1 to 10-6 (S21).

Specifically, the action end determination unit 51 determines whether or not an action in a specific operational component functional unit has ended based on information in the message table. For example, a “processing end time” included in a received message is stored in a “message reception status” record for each action in the message table, and whether or not an action has ended is determined based on whether a “processing end time” of a corresponding record is null or not.

The operation completion determination unit 52 determines, for each partial service and for each maintenance operation, whether or not all actions associated with a series of maintenance operations that are executed in cooperation among the plurality of operational component functional units in the maintenance management system 1 have been completed. For example, a cooperation log that is an execution result of all actions associated with a series of maintenance operations is stored in the message table for each partial service and for each maintenance operation execution, and whether or not a maintenance operation is being executed in a partial service is determined based on whether or not there is a cooperation log containing a null value.

A series of maintenance operations includes operations for executing a plurality of types of functions in cooperation, such as operations for executing an information analysis function using execution results of a test function and an information collection function, and executing a test function based on an execution result of the information analysis function.

Then, when the maintenance worker operates the maintenance terminal and thus the operational component functional unit 60 (a maintenance worker UI) sends a message instructing execution of an action relating to a function type of any of the partial services, for example, execution of a configuration change function (“YES” in S22), the execution possibility determination unit 53 determines whether or not there is a maintenance operation being executed in the partial service based on the determination result of the operation completion determination unit 52 (S23).

Here, if there is no corresponding maintenance operation being executed (“NO” in S23), the execution possibility determination unit 53 determines that the instructed function is capable of being executed (S24). If there is a corresponding maintenance operation being executed (“YES” in S23), the execution possibility determination unit 53 determines that the instructed function is incapable of being executed in order to avoid the problem due to overlapping execution of operations (S25). When it is determined that the instructed function is incapable of being executed, a message for stopping execution of the action of the function relating to the instruction is broadcast.

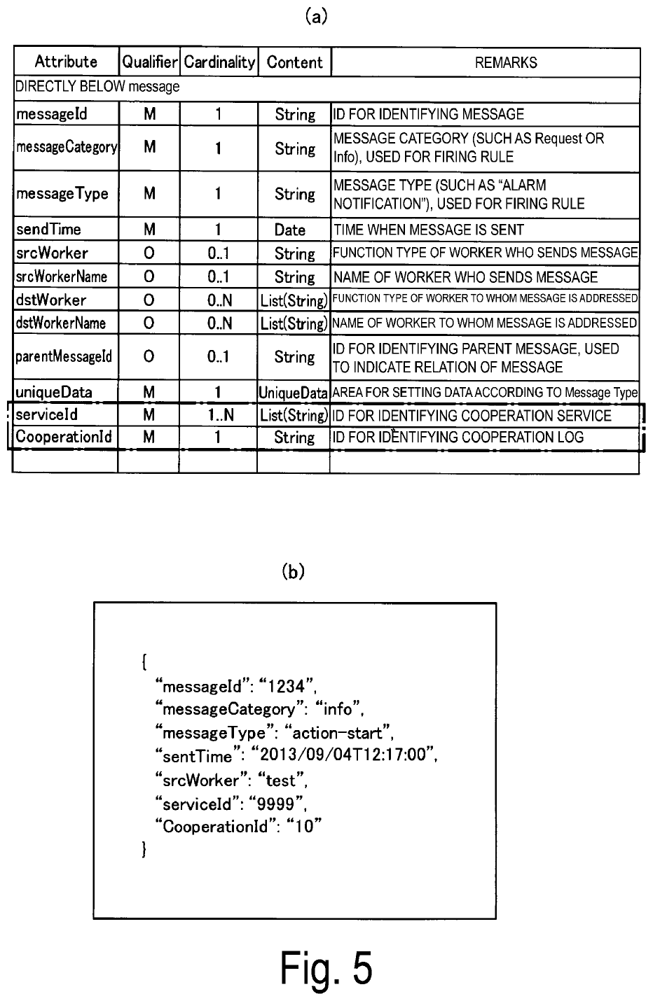

The start message and the end message issued from the action notification unit 17 in the synchronization process (1) for operation transition between a plurality of operational component functional units may include a cooperation service ID for identifying each of the partial services A, B, and C which are used in cooperation in the service X and a cooperation log ID for identifying the cooperation log information that is an execution result of a plurality of functions executed in cooperation in maintenance operations executed in the maintenance management system 1. FIG. 5(a) illustrates an example of common information in a start message and an end message including such cooperation service and log IDs. FIG. 5(b) illustrates an example of a start message using this common information.

According to the above embodiment, when a new partial service is added to a service to be managed and operational component functional units relating to the new partial service are added, these added operational component functional units can execute autonomous operations in cooperation with operational component functional units of existing partial services. Thus, the service can be run at a low cost without requiring complicated configuring. Similarly, when the specifications of an existing partial service are changed or when a new operational component function is added, corresponding operations can be executed with the new specifications without affecting other operational component functional units.

In addition, using a broadcast messaging method for transmitting information between operational component functional units eliminates the need to count and specify the number of operational component functional units in the system and also eliminates the need for each individual operational component functional unit to check operating states of other operational component functional units. Thus, it is possible to flexibly deal with the addition or deletion of operational component functional units.

A maintenance management program for causing a computer to execute the function of each operational component functional unit of the maintenance management system of the present embodiment may also be constructed to cause the computer to operate as a maintenance management device.

### REFERENCE SIGNS LIST

1 Maintenance management system
10-1 to 10-6 Operational component functional unit
11 Action definition storage unit
12 Firing rule storage unit
13 Start/stop unit
14 Execution trigger monitoring unit
15 Action execution unit
16 Data/state storage control unit
17 Action notification unit
18 Message transmission/reception unit
20 Common data storage unit
30 Message bus
40 Action merging determination unit
50 Operation management unit
51 Action end determination unit
52 Operation completion determination unit
53 Execution possibility determination unit
60 Operational component functional unit

1. A maintenance management system for executing, as maintenance processing relating to an application for providing a service including a plurality of partial services, a plurality of types of preset maintenance management functions for each of the plurality of partial services, the maintenance management system comprising:
a plurality of operational component functional units provided for the respective partial services and for the respective maintenance management functions, each of the plurality of operational component functional units including
an execution unit configured to start an action of a corresponding function upon detecting information on a result of determination that an action corresponding to another maintenance management function preset as a preceding stage of the action of the corresponding function has ended in all the partial services, and
an action notification unit configured to issue a start message when the action of the corresponding function starts and issue an end message when the action of the corresponding function ends; and
an action merging determination unit connected to the plurality of operational component functional units via a message bus and configured to determine, for each of the maintenance management functions, whether the corresponding action has ended in all the partial services based on the start message and the end message issued from the action notification unit of each of the operational component functional units, and transmit, upon determining that the corresponding action has ended in all the partial services, corresponding result information to the plurality of operational component functional units.

2. The maintenance management system according to claim 1, further comprising:
an operation management unit connected to the message bus and configured to hold, as cooperation log information, an execution result of a series of maintenance operations that are executed in cooperation among a plurality of operational component functional units for each of the plurality of types, and determine, when an instruction to execute an action relating to a function type of any partial service is acquired, that an instructed function is incapable of being executed upon determining, based on the held cooperation log information, that a series of maintenance operations including the corresponding function are being executed.

3. The maintenance management system according to claim 1, further comprising:
a maintenance management device for performing the maintenance processing relating to an application for providing a service including the plurality of partial services, the maintenance management device being configured to execute a predetermined maintenance management function for a predetermined partial service, the maintenance management device being connected to an action merging determination unit via a message bus, the action merging determination unit being configured to determine, for each maintenance management function, whether a corresponding action has ended in all the partial services, the maintenance management device comprising:
the execution unit configured to start the action of the corresponding function when the action merging determination unit has determined that an action corresponding to another maintenance management function preset as a preceding stage of the action of the corresponding function has ended in all the partial services; and
the action notification unit configured to issue the start message when the action of the corresponding function starts and issue the end message when the action of the corresponding function ends to allow the action merging determination unit to execute processing of determining whether the corresponding action has ended in all the partial services.

4. The maintenance management system according to claim 3, the maintenance management device being configured as an independent process in the maintenance management system, the maintenance management device further comprising:
a start/stop unit configured to connect the maintenance management device to the message bus and set a message-waiting state of the maintenance management device to an on state when an own process has started and disconnect the maintenance management device from the message bus and set the message-waiting state of the maintenance management device to an off state when the own process has ended.

5. The maintenance management system according to claim 3, wherein the action notification unit is configured to incorporate, into each of the start message and the end message, a cooperation service ID for identifying each of the partial services used in the service and a cooperation log ID for identifying cooperation log information that is an execution result of a series of maintenance operations executed in cooperation among a plurality of operational component functional units for each of the plurality of types.

6. A maintenance management method for a maintenance management device installed in a maintenance management system for performing maintenance processing relating to an application for providing a service including a plurality of partial services, the maintenance management device being configured to execute a predetermined maintenance management function for a predetermined partial service, the maintenance management device being connected to an action merging determination unit via a message bus, the action merging determination unit being configured to determine, for each maintenance management function, whether a corresponding action has ended in all the partial services, the maintenance management method comprising:
by the maintenance management device, starting an action of a corresponding function when the action merging determination unit has determined that an action corresponding to another maintenance management function preset as a preceding stage of the action of the corresponding function has ended in all the partial services; and
by the maintenance management device, issuing a start message when the action of the corresponding function starts and issuing an end message when the action of the corresponding function ends to allow the action merging determination unit to execute processing of determining whether the corresponding action has ended in all the partial services.

7. A maintenance management program for a maintenance management device installed in a maintenance management system for performing maintenance processing relating to an application for providing a service including a plurality of partial services, the maintenance management device being configured to execute a predetermined maintenance management function for a predetermined partial service, the maintenance management device being connected to an action merging determination unit via a message bus, the action merging determination unit being configured to determine, for each maintenance management function, whether a corresponding action has ended in all the partial services, the maintenance management program causing the maintenance management device to execute:
starting an action of a corresponding function when the action merging determination unit has determined that an action corresponding to another maintenance management function preset as a preceding stage of the action of the corresponding function has ended in all the partial services; and
issuing a start message when the action of the corresponding function starts and issuing an end message when the action of the corresponding function ends to allow the action merging determination unit to execute processing of determining whether the corresponding action has ended in all the partial services.

8. The maintenance management method according to claim 6, further comprising:
holding, as cooperation log information, an execution result of a series of maintenance operations that are executed in cooperation among a plurality of operational component functional units for each of the plurality of types, and determine, when an instruction to execute an action relating to a function type of any partial service is acquired, that an instructed function is incapable of being executed upon determining, based on the held cooperation log information, that a series of maintenance operations including the corresponding function are being executed.

9. The maintenance management method according to claim 6, further comprising:
performing the maintenance processing relating to an application for providing a service including the plurality of partial services,
executing a predetermined maintenance management function for a predetermined partial service, and
determining, for each maintenance management function, whether a corresponding action has ended in all the partial services, further comprising:
starting the action of the corresponding function when the action merging determination unit has determined that an action corresponding to another maintenance management function preset as a preceding stage of the action of the corresponding function has ended in all the partial services;
issuing the start message when the action of the corresponding function starts; and
issuing the end message when the action of the corresponding function ends to allow for executing processing of determining whether the corresponding action has ended in all the partial services.

10. The maintenance management method according to claim 9, further comprising:
connecting a maintenance management device to the message bus; and
setting a message-waiting state of the maintenance management device to an on state when an own process has started and disconnect the maintenance management device from the message bus and set the message-waiting state of the maintenance management device to an off state when the own process has ended.

11. The maintenance management method according to claim 9, further comprising:
incorporating, into each of the start message and the end message, a cooperation service ID for identifying each of the partial services used in the service and a cooperation log ID for identifying cooperation log information that is an execution result of a series of maintenance operations executed in cooperation among a plurality of operational component functional units for each of the plurality of types.

12. The maintenance management program according to claim 7, further comprising:
performing the maintenance processing relating to an application for providing a service including the plurality of partial services,
executing a predetermined maintenance management function for a predetermined partial service, and
determining, for each maintenance management function, whether a corresponding action has ended in all the partial services, further comprising:
starting the action of the corresponding function when the action merging determination unit has determined that an action corresponding to another maintenance management function preset as a preceding stage of the action of the corresponding function has ended in all the partial services;
issuing the start message when the action of the corresponding function starts; and issuing the end message when the action of the corresponding function ends to allow for executing processing of determining whether the corresponding action has ended in all the partial services.

13. The maintenance management program according to claim 12, further comprising:
connecting a maintenance management device to the message bus; and
setting a message-waiting state of the maintenance management device to an on state when an own process has started and disconnect the maintenance management device from the message bus and set the message-waiting state of the maintenance management device to an off state when the own process has ended.

14. The maintenance management program according to claim 12, further comprising:
incorporating, into each of the start message and the end message, a cooperation service ID for identifying each of the partial services used in the service and a cooperation log ID for identifying cooperation log information that is an execution result of a series of maintenance operations executed in cooperation among a plurality of operational component functional units for each of the plurality of types.
